(19) United States
(12) Patent Application Publication
(10) Pub. No.: US 2005/0031857 A1
(43) Pub. Date: Feb. 10, 2005

(54) Anti-fog sheet material for food container and its fabrication method

(76) Inventor: Shyh-Jier Gau, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/635,559

(22) Filed: Aug. 7, 2003

(51) Int. Cl. B32B 27/00; B32B 33/00; B05D 3/12; B05D 3/06

(52) U.S. Cl. 428/337; 428/411.1; 427/322; 427/569; 427/374.1

(57) ABSTRACT

An anti-fog sheet material is constructed to include a transparent plastic base sheet of about 0.13˜0.55 mm thick, which has capillary tubes in top and bottom surfaces thereof, and an anti-fog film coated on the bottom surface of the transparent plastic base sheet, the anti-fog film being formed of a liquid mixture of sucrose fatty acid esters and ethyl alcohol and water, the liquid mixture having dry matter 39˜43%, acid value less than 3.0 mg KoH/g, residue on ignition less than 0.6%, arsenic content less than 1 ppm, and heavy metals less than 10 ppm.

### BACKGROUND OF THE INVENTION

1. Field of the Invention

The present invention relates to an anti-fog sheet material for food container, and relates also to the fabrication of such an anti-fog sheet material. During fabrication, the top and bottom surfaces of the prepared transparent plastic base sheet material are coarsened and then surface-treated with corona, causing capillary tubes to be formed in the surfaces of the plastic base sheet material for positive bonding of an anti-fog coating and a stripping film.

2. Description of the Related Art

Condensing of water drops on the surface of a glass member or lens may occur upon a temperature or humility change, affecting the transparency of the glass member or lens. In order to eliminate the problem of fogging, it is necessary to treat the surface with an anti-fog treatment. Various prior art anti-fog techniques are known. For example, the technique of coating the workpiece with a layer of polymeric compound coating by dipping; the technique of coating the workpiece with a layer of compound film containing ionic active agent and inorganic salt; the technique of coating the workpiece with a simple layer or multi-layer of compound film containing polyethylene alcohol, silicon particles and organic silicon compound. Similar methods are seen in U.S. Pat. Nos. 4,242,412; 4,332,859; 5,675,133; 4,478,909; 5,134,021.

However, conventional anti-fog coating techniques are not practical for use in the fabrication of disposable transparent plastic sheet members for food container due to the following problems:

1. As shown in FIG. 1, because disposable plastic food containers 1 are to be disposed in contact with food, their coating must be in conformity with food safety regulations.

2. Because disposable plastic food containers 1 are cheap materials having a certain dimension, it is not economic to coat disposable plastic food containers 1 with an anti-fog coating like a lens. The most cost-effect method is to have the whole roll of plastic sheet member finished with an anti-fog treatment in the factory before delivering the roll of plastic sheet member to the food container maker. Upon receipt of an anti-fog treated roll of plastic sheet member, the food container maker can use an automatic machine to process the anti-fog treated roll of plastic sheet member into individual disposable plastic food containers. When making plastic sheet members, thermoplastic resins are extruded through a compounding extruder into a base sheet material, which is than processed in proper order through a series of processing processes including M.D.O (Machine Direction Orienter) process, T.D.O (Transverse Direction Orienter) process, take-off process, cooling process, and winding process. Further, the plastic sheet member must be coated with a layer of stripping coating so that the finished disposable plastic food containers do not adhere to one another when arranged in a stack (see FIG. 2). This stripping coating procedure can easily be achieved by conventional techniques. However, it is not easy to have the bottom and top surfaces of the plastic sheet member be coated with a layer of anti-fog coating and a layer of stripping coating by means of conventional techniques. Uneven coating of stripping coating may causes a transfer-writing problem, which may not easily be found by the worker during fabrication of the plastic sheet member. Further, when rolling up the finished plastic sheet member, the coatings on the top and bottom surfaces of the finished plastic sheet member may interfere with each other, causing a transfer-writing problem. Due to the aforesaid problems, water drops tend to be condensed at the transfer-writing area on the bottom surface of the plastic cover 11 of a food container made according to conventional techniques.

3. Furthermore, conventional disposable plastic food containers are commonly not tough, and tend to be distorted or wrinkled.

### SUMMARY OF THE INVENTION

The present invention has been accomplished under the circumstances in view. It is the main object of the present invention to provide an anti-fog sheet material, which eliminates the aforesaid problems. It is another object of the present invention to provide an anti-fog sheet material, which has stable physical properties, preventing interference or transfer-writing (printing) of coatings. It is another object of the present invention to provide an anti-fog sheet material, which has a high toughness for durable application. It is still another object of the present invention to provide an anti-fog sheet material fabrication method, which is efficient and economic.

According to the present invention, the anti-fog sheet material comprises a transparent plastic base sheet of about 0.13˜0.55 mm thick, which has capillary tubes in top and bottom surfaces thereof, and an anti-fog film coated on the bottom surface of the transparent plastic base sheet, the anti-fog film being formed of a liquid mixture of sucrose fatty acid esters and ethyl alcohol and water, the liquid mixture having dry matter 39˜43%, acid value less than 3.0 mg KoH/g, residue on ignition less than 0.6%, arsenic content less than 1 ppm, and heavy metals less than 10 ppm. The coating material for the stripping film is a dimethyl silicon oil-based weak anionic emulsion. The polymeric compound contains 98 wt % base material selected from one of a plastic group including PS, PP, PET, PVC, and PE, and 2 wt % functional plastic compound containing styrene 67˜73 wt %, 27˜33 wt % butadiene, and additive less than 1%.

### BRIEF DESCRIPTION OF THE DRAWINGS

FIG. 1 illustrates a conventional plastic food container.

FIG. 2 illustrates a plurality of conventional plastic food containers arranged in a stack.

FIG. 3 is a schematic drawing showing fogs formed inside a conventional plastic food container.

FIG. 4 is a schematic block diagram of the present invention.

FIG. 5 is a schematic drawing showing the base sheet material delivered through the impression cylinders of the rolling machine according to the present invention.

FIG. 6 is a sectional view showing the surfaces of the base sheet material coarsened according to the present invention.

FIG. 7 is a schematic drawing showing the secondarily treated plastic base sheet material delivered through a corona machine according to the present invention.

FIG. 8 illustrates capillary tubes formed in the top and bottom surfaces of the plastic base sheet material after the corona treatment according to the present invention.

FIG. 9 is a schematic drawing showing the anti-fog film and the stripping film respectively coated on the bottom and top surfaces of the plastic base sheet material according to the present invention.

FIG. 10 illustrates an alternate form of the anti-fog film and stripping film coated plastic base sheet material according to the present invention.

FIG. 11 is a perspective view of a plastic cover for food container constructed according to the present invention.

FIG. 12 is a schematic drawing showing the test of an anti-fog plastic food container made according to the present invention.

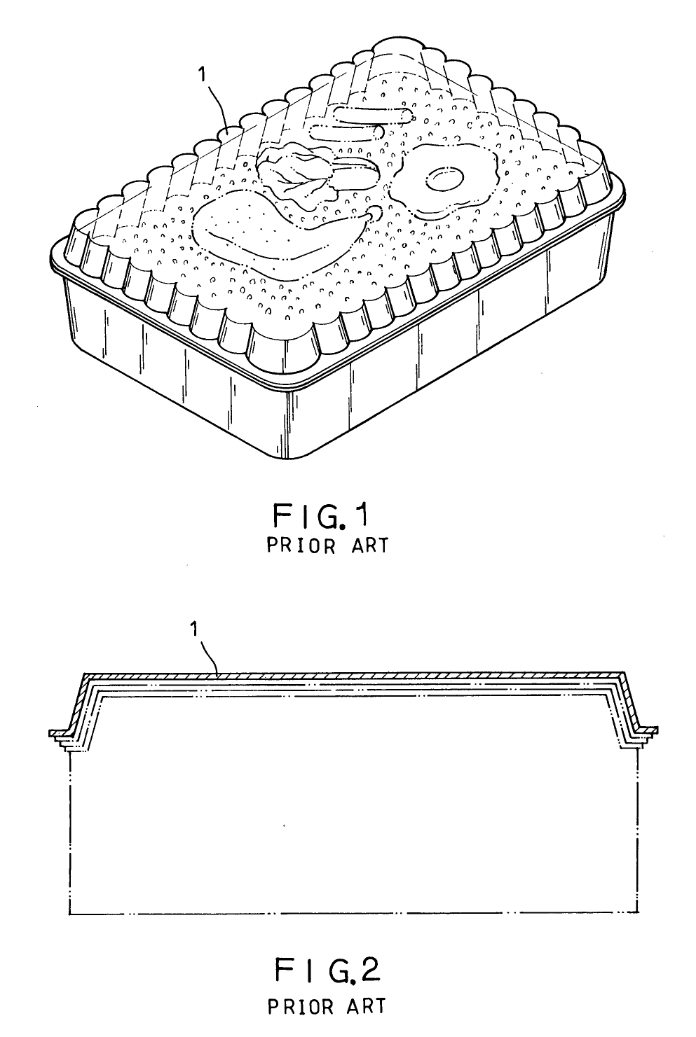

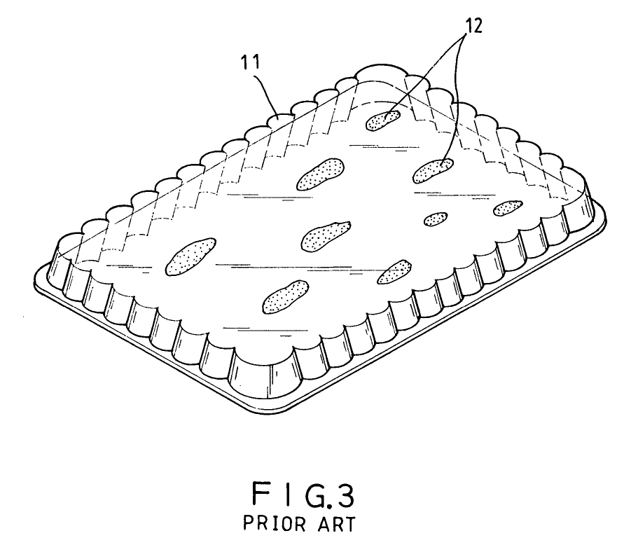

### DETAILED DESCRIPTION OF THE PREFERRED EMBODIMENT

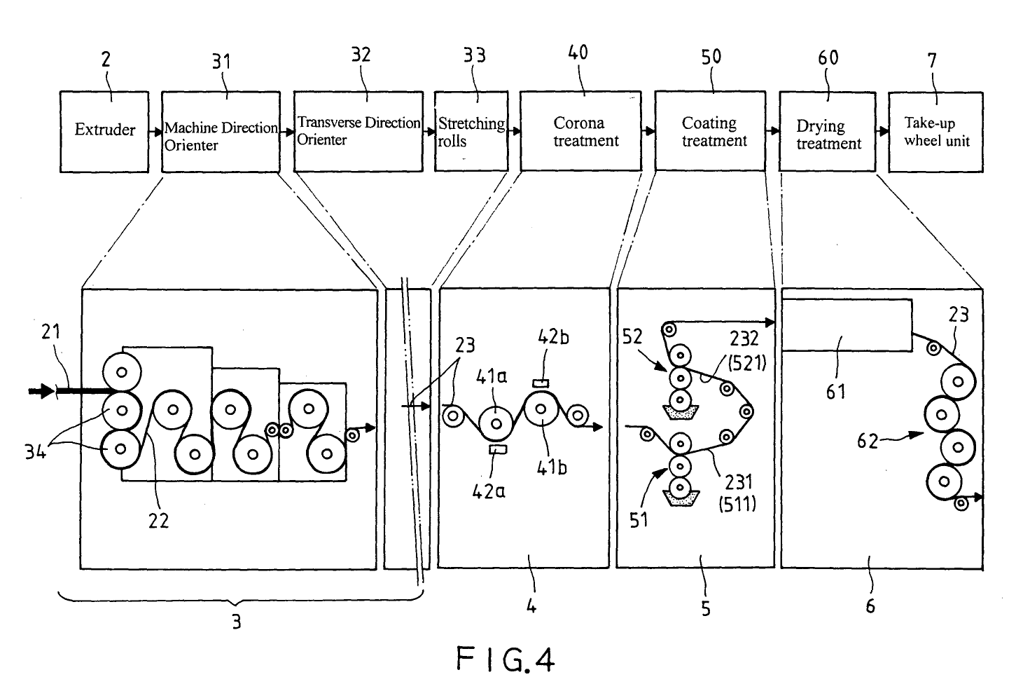

Referring to FIG. 4, an anti-fog sheet material fabrication method in accordance with the present invention comprises the steps of:

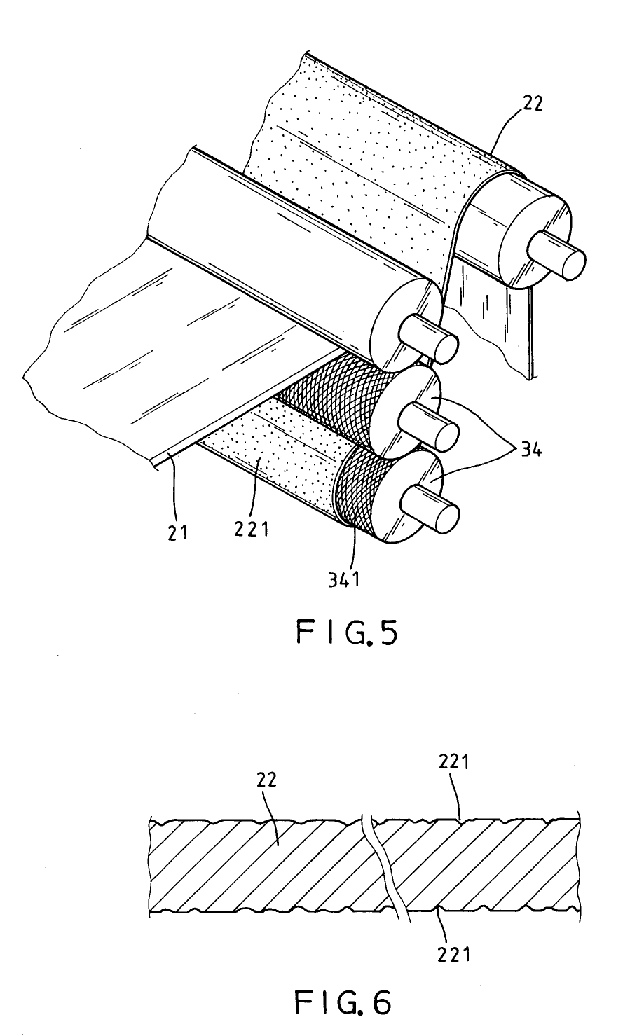

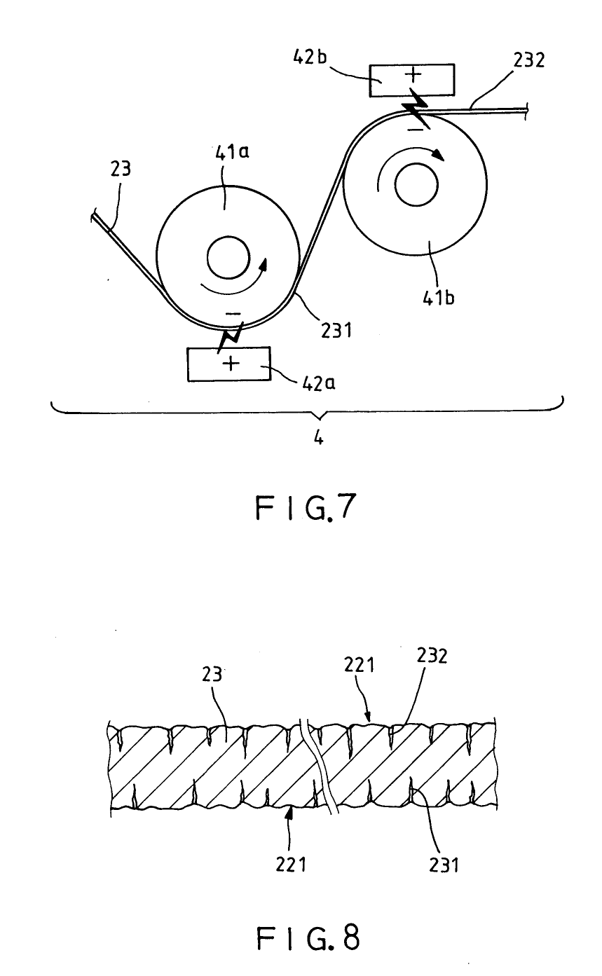

(a) preparing a softened hot base sheet material 21 obtained from a polymeric compound through an extruder 2, and then processing the base sheet material 21 through the M.D.O (Machine Direction Orienter) 31 of a rolling machine 3 into a primarily treated plastic base sheet material 22 having coarsened top and bottom faces of about 100˜150 meshes 221, which M.D.O (Machine Direction Orienter) 31 comprising impression cylinders 34 having a respective coarse surface 341, which may be formed on the respective impression cylinder by embossing or sand-blasting, and then processing the primarily treated plastic base sheet material 22 through the T.D.O (Transverse Direction Orienter) 32 and stretching rolls 33 of the rolling machine 3 so as to obtain a secondarily treated plastic base sheet material 23 having a thickness within about 0.13˜0.55 mm, (see FIGS. 5 and 6);

(b) delivering the secondarily treated plastic base sheet material 23 through the gap in between the roll of first negative electrode 41a and the roll of first positive electrode 42a and the gap in between the roll of second positive electrode 42b and the roll of second negative electrode 41b in a corona machine 4 to apply a corona treatment 40 to the secondarily treated plastic base sheet material 23, thereby causing capillary tubes to be formed in the top (outer) surface 232 and bottom (inner) surface 231 of the plastic base sheet material 23 (see FIG. 8);

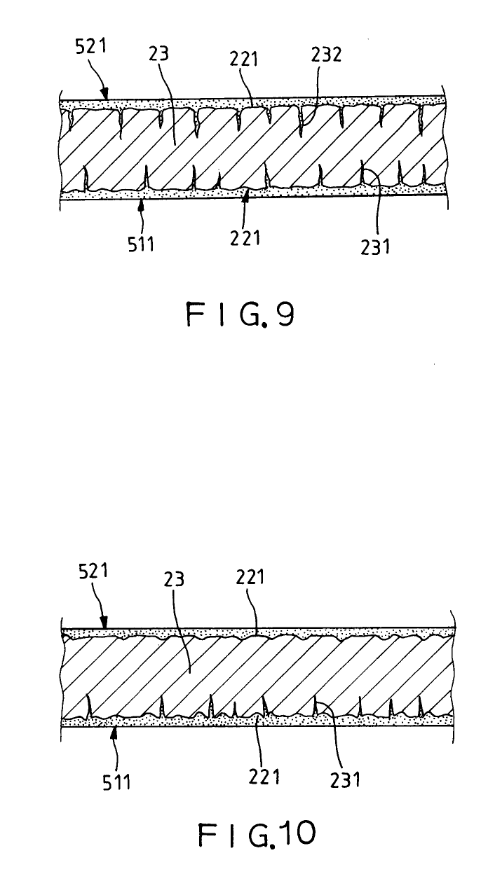

(c) sending the corona treated plastic base sheet material 23 to a coating machine 5 to receive an anti-fog coating treatment 50 where the bottom (inner) surface 231 of the corona treated plastic base sheet material 23 is coated by a first applicator wheel assembly 51 (of which the meshed applicator wheel has about 250 meshes) with a layer of anti-fog film 511 formed of a liquid mixture of sucrose fatty acid esters and ethyl alcohol and water, such liquid mixture having dry matter 39˜43%, acid value less than 3.0 mg KoH/g, residue on ignition less than 0.6%, arsenic content less than 1 ppm, and heavy metals less than 10 ppm; the top (outer) surface 232 of the corona treated plastic base sheet material 23 is coated by a second applicator wheel assembly 52 (of which the meshed applicator wheel has about 300 meshes) with a layer of stripping film 521 (see FIGS. 9 and 10);

(d) sending the coated plastic sheet material 23 to a dryer 6 to receive a drying treatment 60, which dryer 6 comprising a baking oven 61, which dries the coated plastic sheet material 23 at about 76° C.˜105° C., and a cooling wheel set 62, which carries the dried plastic sheet material 23 out of the baking oven 61 and cools down the temperature of the dried plastic sheet material 23 to a level below 40° C.; and

(e) using a roll-up wheel unit 7 to roll up the finished sheet material into a roll.

The invention is performed in an automatic fabrication line. The top and bottom surfaces of the base material are coarsened and then surface-treated with corona, causing capillary tubes to be formed in the bottom (inner) surface of the plastic base sheet (see FIG. 9) or in both the top (outer) and bottom (inner) surfaces of the plastic base sheet (see FIG. 10) for positive bonding of the anti-fog coating and the stripping film. The liquid mixture of sucrose fatty acid esters, ethyl alcohol and water for the anti-fog coating is in conformity with food safety regulations. Sucrose fatty acid esters are dissolvable in alcohol. When coated on the plastic base sheet, the liquid mixture forms a thin layer of anti-fog coating of thickness within about 30 nm˜300 nm. The coating material for the stripping film is a dimethyl silicon oil-based weak anionic emulsion that can easily be obtained from the market. The coating of the stripping film can easily be bonded to the surface of the plastic base sheet. Therefore, it is not imperative to treat the top (outer) surface of the plastic base sheet with corona. However, treating the top (outer) surface of the plastic base sheet with corona enhances the bonding of the coating of the stripping film to the plastic base sheet.

In order to obtain an anti-fog sheet member of high toughness, the polymeric compound for the aforesaid base sheet material 21 contains 98 wt % base material selected from PS, PP, PET, PVC, or PE, and 2 wt % functional plastic compound containing styrene 67˜73 wt %, 27˜33 wt % butadiene, and additive less than 1%.

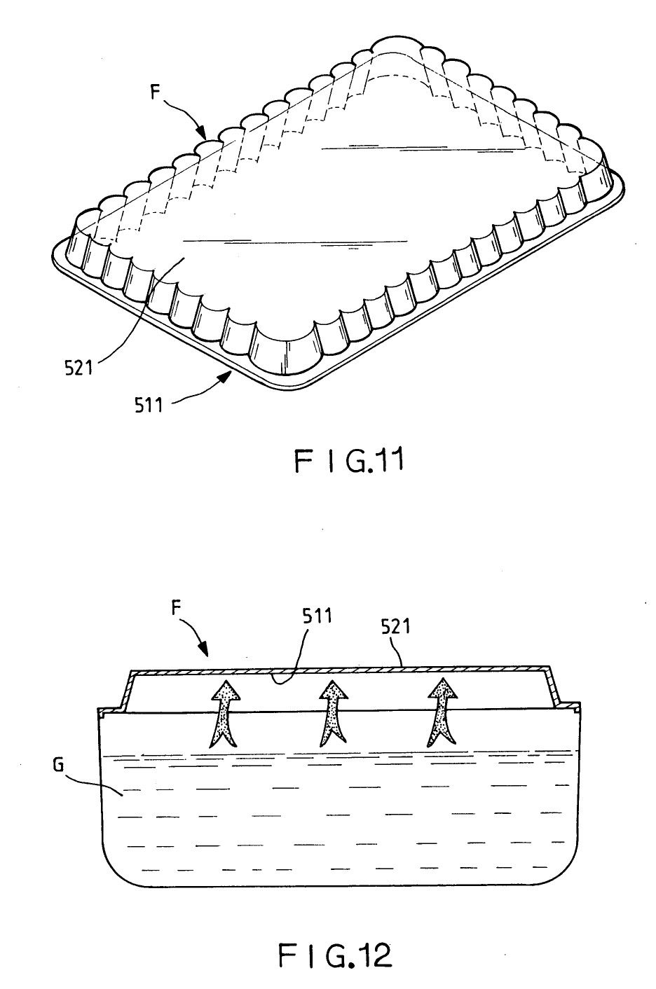

FIG. 11 illustrates a plastic cover F for a food container made of an anti-fog sheet material obtained subject to the aforesaid fabrication method, which has an anti-fog film 511 coated on the bottom (inner) surface and a stripping film 521 coated on the top (outer) surface. Because the anti-fog film 511 and the stripping film 521 are respectively coated on the bottom (inner) and top (outer) surfaces of the plastic sheet that have capillary tubes, the coatings of the anti-fog film 511 and the stripping film 521 do not come off easily. When adhered an adhesive tape to the plastic cover F and then split the adhesive tape from the plastic cover, the coatings of the anti-fog film 511 and the stripping film 521 maintained intact. When put the food container in 98° C. hot water G for about 30 seconds, no fog was seen in the anti-fog film 511 on the bottom (inner) surface of the plastic cover F (see FIG. 12). Thereafter, removed the food container from hot water G and put the food container in the open air for about 30 minutes, and then put the food container in hot water G again to see any presence of fog or condensed water drops. After more than ten times of tests, the anti-fogging effect of the plastic cover F was still prominent. The aforesaid tests prove that the invention is innovative, and has an industrial value.

While only one embodiment of the present invention has been illustrated and described, it will be understood that various modifications and enhancements could be made thereunto without departing from the spirit and scope of the invention. Accordingly, the invention is not to be limited except as by the appended claims.

1. An anti-fog sheet material comprising:
a transparent plastic base sheet having capillary tubes in top and bottom surfaces thereof at 100˜150 meshes, and a thickness about 0.13˜0.55 mm; and
an anti-fog film coated on the bottom surface of said transparent plastic base sheet, said anti-fog film being formed of a liquid mixture of sucrose fatty acid esters and ethyl alcohol and water, said liquid mixture having dry matter 39˜43%, acid value less than 3.0 mg KoH/g, residue on ignition less than 0.6%, arsenic content less than 1 ppm, and heavy metals less than 10 ppm.

2. The anti-fog sheet material as claimed in claim 1, wherein said anti-fog film has a thickness about 30 nm˜300 nm.

3. The anti-fog sheet material as claimed in claim 1, further comprising a stripping film coated on the top surface of said transparent plastic base sheet.

4. An anti-fog sheet material fabrication method comprising the steps of:
(a) preparing a softened hot base sheet material obtained from a polymeric compound through an extruder, and then processing the base sheet material through the M.D.O (Machine Direction Orienter) of a rolling machine into a primarily treated plastic base sheet material having coarsened top and bottom faces of about 100˜150 meshes, and then processing the primarily treated plastic base sheet material through the T.D.O (Transverse Direction Orienter) and stretching rolls of the rolling machine so as to obtain a secondarily treated plastic base sheet material;
(b) delivering the secondarily treated plastic base sheet material thus obtained from step (a) through gaps in between the rolls of negative electrode and the rolls of positive electrode in a corona machine to apply a corona treatment to the secondarily treated plastic base sheet, thereby causing capillary tubes to be formed in top and bottom surfaces of the plastic base sheet material;
(c) sending the corona treated plastic base sheet material to a coating machine to receive an anti-fog coating treatment where the bottom surface of the corona treated plastic base sheet is coated by a first applicator wheel assembly with a layer of anti-fog film formed of a liquid mixture of sucrose fatty acid esters and ethyl alcohol and water, such liquid mixture having dry matter 39˜43%, acid value less than 3.0 mg KoH/g, residue on ignition less than 0.6%, arsenic content less than 1 ppm, and heavy metals less than 10 ppm; the top surface of the corona treated plastic base sheet is coated by a second applicator wheel assembly with a layer of stripping film;
(d) sending the coated plastic sheet material to a dryer to receive a drying treatment at about 76° C.˜105° C., and then cooling the dried plastic sheet material to a temperature level below 40° C.; and
(e) using a take-up wheel unit to roll up the finished sheet material into a roll.

5. The anti-fog sheet material fabrication method as claimed in claim 4, wherein said first applicator wheel assembly comprises a meshed applicator wheel having about 250 meshes; said second applicator wheel assembly comprises a meshed applicator wheel having about 300 meshes.

6. The anti-fog sheet material fabrication method as claimed in claim 4, wherein said polymeric compound for said base sheet material contains 98 wt % base material selected from one of a plastic group including PS, PP, PET, PVC, and PE, and 2 wt % functional plastic compound containing styrene 67˜73 wt %, 27˜33 wt % butadiene, and additive less than 1%.
